(19) United States
(12) Patent Application Publication
(10) Pub. No.: US 2021/0388511 A1
(43) Pub. Date: Dec. 16, 2021

(54) PROCESS FOR ELECTROCHEMICAL PREPARATION OF AMMONIA

(71) Applicants: thyssenkrupp Industrial Solutions AG, Essen (DE); thyssenkrupp AG, Essen (DE)

(72) Inventors: Joachim JOHANNING, Oberhausen (DE); Daniela DOSTAL, Dortmund (DE)

(73) Assignees: thyssenkrupp Industrial Solutions AG, Essen (DE); thyssenkrupp AG, Essen (DE)

(21) Appl. No.: 17/458,981

(22) Filed: Aug. 27, 2021

Related U.S. Application Data
(62) Division of application No. 16/319,129, filed on Jan. 18, 2019.

(30) Foreign Application Priority Data
Jul. 21, 2016 (DE) 10 2016 213 360.8

(51) Int. Cl. C25B 1/00; C25B 15/08; C25B 9/70; C25B 1/27

(52) U.S. Cl. CPC C25B 1/00; C25B 15/08; C25B 1/27; C25B 15/083; C25B 15/087; C25B 9/70

(57) ABSTRACT

A process for preparing ammonia via an electrolysis cell may involve feeding nitrogen as a first reactant into the electrolysis cell and using water or water vapor as a second reactant for electrolysis. In at least one step downstream of the electrolysis, there is a separation of other components from the ammonia, such as an at-least-partial separation of nitrogen, water, argon and/or hydrogen. Recovery of the reactants is connected upstream of the ammonia electrolysis. The nitrogen used as the first reactant may be procured beforehand in an air fractionation plant. The process may further involve removing from the electrolysis cell oxygen formed as a by-product in the electrolysis at an anode.

### CROSS REFERENCE TO RELATED APPLICATIONS

This application is a divisional application of U.S. patent application Ser. No. 16/319,129, filed Jan. 18, 2019, which is a U.S. National Stage Entry of International Patent Application No. PCT/EP2017/067820, filed Jul. 14, 2017, which claims priority to German Patent Application No. DE 10 2016 213 360.8, filed Jul. 21, 2016, the entire contents of all of which are incorporated herein by reference.

### FIELD

The present disclosure generally relates the preparation of ammonia, including processes for preparing ammonia by electrolysis using at least one electrolysis cell.

### BACKGROUND

Ammonia is one of the most important raw materials. Global annual production is currently about 170 million metric tonnes. The greatest portion of the ammonia is used for production of fertilizers. Industrial scale production nowadays largely uses the high-pressure synthesis in fixed bed reactors with iron as catalytically active main component that was developed by Haber and Bosch at the start of the 20th century, based on a synthesis gas of stoichiometric composition with the main components hydrogen and nitrogen. The synthesis gas is produced predominantly via the natural gas route. A disadvantage here is the large amounts of carbon dioxide obtained.

As a result of the high temperatures of, for example, about 400° C. to about 500° C. and pressures in the order of magnitude of, for example, about 100 bar to about 450 bar that are required for the ammonia synthesis, and the effects of the process media on the materials of value under these conditions, the ammonia synthesis reactors are technically very demanding apparatuses. They are comparatively sensitive to changes in the operating conditions. Every plant shutdown is associated with a significant reduction in lifetime.

The exothermic character of the ammonia formation reaction gives rise to comparatively large amounts of heat in the course of the process. For good specific energy consumption in the overall process, they have to be utilized with maximum efficiency. In general, the utilization of waste heat is associated with thermodynamically unavoidable losses. There has therefore been no lack of attempts to develop alternatives to the Haber-Bosch process that work without the high temperatures and pressures. In the Haber-Bosch process, the fundamental difficulty of activation of the very unreactive nitrogen molecule is overcome by the use of specifically very active catalysts in combination with comparatively high temperatures. An alternative for the provision of the activation energy required is the use of electrical energy. For this purpose, there now exist solution concepts capable of working on the laboratory scale.

Many laboratory concepts for electrolysis of ammonia are based on the use of hydrogen and nitrogen in a cell. In this case, first of all, the hydrogen has to be conventionally produced, associated with the disadvantages indicated above. In addition, there are recurring efforts to produce ammonia in an electrolysis cell from nitrogen and water.

US 2010/0200418 A1 describes a relatively novel, promising electrolysis cell concept in which heat and electricity are obtained simultaneously from sunlight for electrochemical production of substances, for example carbon or iron, in high-energy processes (called the STEP process: Solar Thermal Electrochemical Photo process). In this process, the electrolyte used is molten alkali metal carbonate and the temperatures in the electrolysis are usually more than 650° C.

There is no industrial scale plant concept in existence to date in which excess electrical energy is utilized efficiently for production of ammonia in an electrolysis cell from the reactants nitrogen and water.

DE 1 220 401 A describes a process for producing synthesis gas for ammonia synthesis and for producing ammonia, in which, in a water electrolysis with catalyst electrodes, the cathode is additionally purged with air. The oxygen is reacted here with hydrogen formed at the cathode to give water and a hydrogen/nitrogen mixture suitable for synthesis is produced. The catalyst electrode can be modified such that it also catalyzes the formation of ammonia, such that the reaction produces ammonia or a mixture of ammonia and synthesis gas.

DE 10 2012 216 090 A1 describes a green integrated plant for production of chemical and petrochemical products, which comprises a combined air fractionation and carbon dioxide separation plant in which carbon dioxide and nitrogen are obtained, and which further comprises an electrolysis unit for obtaining hydrogen, wherein the nitrogen from the combined air fractionation and carbon dioxide separation plant and the hydrogen obtained by electrolysis are converted to a wide variety of different chemical products, including ammonia as well as methanol, synthesis gas, methane, fuel. The integrated plant comprises a further unit in which renewable energy which is required for the operation of the air fractionation and carbon dioxide separation plant and the electrolysis unit is generated.

An electrolysis cell for electrochemical synthesis of ammonia is described, for example, in U.S. Pat. No. 6,712,950 B1. No aqueous solution is used in this process; instead a molten lithium salt (Li₃N) as electrolyte is electrolyzed at high temperatures of between 300° C. and 600° C. Hydrogen is guided to the anode, and negatively charged nitride ions migrate in the melt to the anode, where they are oxidized to atomic nitrogen and react with hydrogen to give ammonia.

WO 2014/160 792 A1 describes a process for electrochemical conversion of molecular nitrogen and hydrogen to ammonia in an electrochemical cell in alkaline solution using carbon electrodes that have been electroplated with platinum-iridium. It is possible here to work at comparatively low temperatures of 25° C. to 205° C.

EP 058 784 B1 describes a process for continuously preparing nitrogen oxide as starting material for obtaining nitric acid. This process uses a high-temperature electrolysis cell that works at temperatures in the range from 800° C. to 1000° C. and a high-temperature solid-state electrolyte suitable for oxygen ion transport. The electrolysis cell comprises a porous cathode which is supplied with water vapor and a porous anode which is supplied with NH₃. The hydrogen formed at the cathode is reacted with nitrogen in a conventional NH₃ synthesis apparatus by the Haber-Bosch process and a portion of the ammonia thus produced is used to feed the anode of the electrolysis cell. The ammonia is oxidized in the electrolysis cell with the nascent oxygen obtained in the water electrolysis to give nitrogen oxide and water vapor. In this process, water vapor is thus electrolyzed in the electrolysis cell, while the NH₃ is prepared in the conventional Haber-Bosch apparatus and not in the electrolysis cell.

US 2008/0193360 A1 describes a process for anhydrous preparation of ammonia in which protons are separated from water vapor on one side of a proton-conducting electrolyte, and these protons are reacted with nitride ions formed from nitrogen on the other side of the proton-conducting electrolyte for production of anhydrous ammonia. The first reactant fed into the electrolysis cell here is nitrogen, and the second reactant water vapor. The reaction is conducted at a pressure of between 10 and 200 atm and at a temperature of between 400° C. and 800° C. The proton-conducting electrolyte used is a perovskite that has been doped with a lanthanide. This proton-conducting electrolyte takes the form of a tubular solid-state electrolyte.

DE 10 2015 211 391 A1 discloses an apparatus for synthesis of hydrocarbons or ammonia, in which a tubular electrochemical cell that conducts hydrogen ions with a tubular solid-state electrolyte is likewise used. The reactants supplied to the electrolysis apparatus are water vapor and nitrogen. In the ammonia synthesis, the reactants are compressed here to a pressure of 30 MPa. In the synthesis region, a bed of catalyst pellets of magnetite with cobalt as promoter is used. It is mentioned that the ammonia formed is supplied to a condenser and then stored in liquid form. However, this publication does not describe any further separation steps for processing of the product stream.

An article by Stuart Licht et al. in Science 345 (6197), Aug. 7, 2014, pages 637-640, describes electrochemical ammonia synthesis from nitrogen and steam in suspensions of molten hydroxide salts with a catalyst based on nanoscale iron oxide. However, it is pointed out that the catalyst suspension is stable only for a few hours. This article is a scientific study in which there is no description of any steps for the processing and purification of ammonia by separation processes.

Thus a need exists for a process for preparing ammonia in an electrolysis cell suitable for use in industrial scale plants.

### BRIEF DESCRIPTION OF THE FIGURES

FIG. 1 is a schematic simplified block diagram of an example process for preparing ammonia.

FIG. 2 is a more-detailed schematic flow diagram of another example process.

FIG. 3 is an even-more detailed diagram of an example plant design.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

The present disclosure generally relates to processes for preparing ammonia by electrolysis using at least one electrolysis cell. Nitrogen, as a first reactant, may be fed into the electrolysis cell, and water or water vapor may be used as a second reactant for the electrolysis.

In some example processes of the present disclosure, at least one step downstream of the electrolysis involves separation of other components from the ammonia, especially an at least partial separation of one or more components from the group comprising nitrogen, water, argon and hydrogen.

According to some examples of the present disclosure, in a first device, nitrogen and optionally argon are separated from the product stream removed from the electrolysis cell and, in a further device connected in the flow pathway downstream of the first device, water is separated from the remaining ammonia-containing product stream.

These separation/purification steps are generally advisable in order to obtain the ammonia as the process product in the desired specification.

There is no process in existence to date for the industrial scale preparation of ammonia based on an electrolysis cell in which water and nitrogen are used as starting materials. Therefore, in the context of the present invention, a concept for a process and a plant in which this specific electrolysis cell is used has been developed.

The obtaining of the reactants is connected upstream of the ammonia electrolysis. Preferably, according to the invention, the nitrogen used as the first reactant has been obtained in an air fractionation plant beforehand. In this case, the argon that likewise occurs in air can be separated off before the nitrogen is fed into the electrolysis cell, such that the nitrogen used does not contain any argon. It is advantageous here that the purge volume in the process can be reduced. In the best case, the purge is dispensed with entirely. In processes of this kind, in which a gas mixture is being circulated, “purge” means that inert gases, for example argon, are discharged from the circuit since they would otherwise accumulate in the product stream. If the purge discharges inert gases, however, this also always means the loss of a proportion of the reactants and the product gas, and, if these are to be recovered, further processing steps that may be complex are necessary.

Purge gases that are inert in respect of the ammonia synthesis may, since they generally also contain hydrogen, in a preferred development of the invention, be used at least partly as fuels for the generation of water vapor required in the process.

This increases the effectiveness and yield of the process when at least one of the nitrogen and water components that are separated off in step c) is recycled into the electrolysis process, and preferably both components are recycled into the electrolysis process as reactants.

Oxygen formed as by-product at the anode in the electrolysis is preferably removed from the electrolysis cell, optionally purified and separated off.

The ammonia obtained in the electrolysis is preferably separated off in multiple component steps, wherein, more particularly, the ammonia, in at least one further step d), optionally after removal of other components in step c), is purified in a refrigeration plant.

The water vapor used as the second reactant can be produced, for example, in a steam boiler. Alternatively, the water vapor and nitrogen reactants can also come from an operating medium grid, for example.

In one possible preferred variant, in the process of the invention, liquid water is fed into the electrolysis cell and the water vapor used as the second reactant is generated in the electrolysis cell by supply of energy and evaporation of water that has been fed in.

According to the invention, the electrolytic conversion of nitrogen and water to ammonia is advantageously effected at elevated temperatures, especially at a temperature of at least about 150° C.

Preferably, according to the invention, the electrolytic conversion of nitrogen and water to ammonia is effected at elevated pressure, especially at a pressure of at least about 10 bar.

In the process of the invention, two or more electrolysis cells may be provided, which are optionally operated batchwise.

The present invention further provides a plant for preparation of ammonia, comprising:
at least one electrolysis cell suitable for production of ammonia;
at least one device for supply of gaseous nitrogen to this electrolysis cell;
at least one device for supply of water vapor or liquid water to this electrolysis cell;
at least one device for removal of a product stream from this electrolysis cell;
at least one device for separation of one or more components other than ammonia from the product stream removed from the electrolysis cell; and
at least one device for recycling water or water vapor to the electrolysis cell.

This plant preferably further comprises:
at least one device for recycling of nitrogen to the electrolysis cell.

The plant of the invention optionally further comprises:
at least one refrigeration plant, downstream of the device for separation of components other than ammonia, for purification of the ammonia.

Preferably, the plant of the invention further comprises at least one air fractionation plant, upstream of the electrolysis cell, in which nitrogen which is supplied to the electrolysis cell is generated.

Preferably, the plant of the invention further comprises at least one steam generator in which water vapor which is supplied to the electrolysis cell is generated.

Preferably, the plant of the invention further comprises at least one device for separation of oxygen present in a by-product stream removed from the electrolysis cell, especially a separator in which water is removed from an oxygen stream.

More preferably, the plant of the invention further comprises at least one first device for separation of nitrogen and optionally argon from the product stream removed from the electrolysis cell and a further device, downstream in the flow pathway, for separation of water from the remaining ammonia-containing product stream.

More preferably, the plant of the invention comprises two or more electrolysis cells that are preferably each operable batchwise, by means of which continuous operation of the plant can be implemented.

The process of the invention is based in principle mainly on the sequence of at least three operating steps. The first operating step comprises an electrolysis in which ammonia is produced from the nitrogen and water reactants.

The obtaining of these reactants is connected upstream of the first operating step. The nitrogen can be obtained, for example, in an air fractionation plant. The argon that likewise occurs in air can likewise be separated off separately here, so that the nitrogen used does not contain any argon.

The apparatus for production of ammonia from nitrogen and water may consist of multiple cell elements. As well as ammonia at the cathode, oxygen is formed as a by-product at the anode. The ammonia formed also contains the unconverted nitrogen and water vapor reactants and, according to the embodiment of the LZA (air fractionation plant), argon as well. Hydrogen can also form in the electrical cell according to the operating conditions. With the chosen temperatures and pressures, however, unwanted H₂ formation is largely suppressed.

In order to obtain the ammonia product in the desired specification, at least two further operating steps are preferably effected. First of all, the ammonia is separated off, and this may in turn consist of multiple individual steps. In this case, on the basis of the concept of the present invention, both nitrogen and water can be separated off in such a way that these components can be reused as reactants. A portion of the water removed can preferably be utilized for purification. If the nitrogen used contains argon, a portion of the recycled nitrogen/argon mixture is preferably removed.

In the third operating step, in one development of the present disclosure, the ammonia is then preferably purified in a refrigeration plant such that it meets the typical product specification. The inert gases separated off are preferably supplied to the upstream process step.

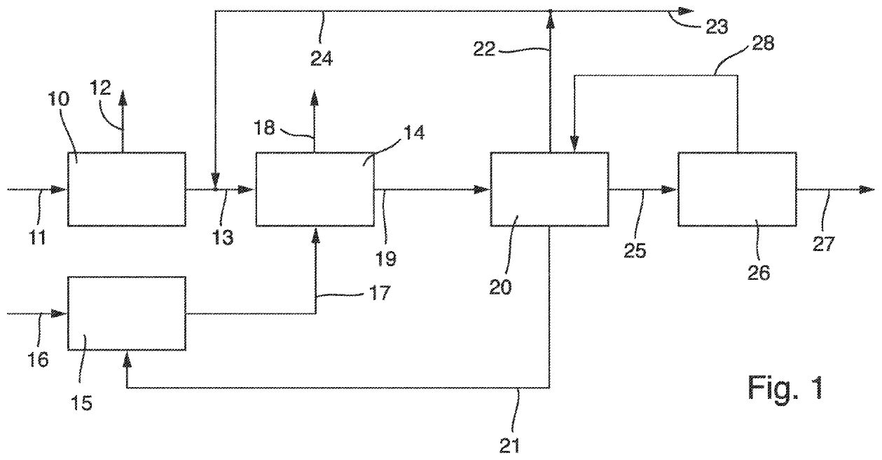

Reference is made first of all to FIG. 1 and this schematic diagram is used to give a detailed description of a first illustrative embodiment of a process of the invention. A plant for performing the process comprises, for example, an air fractionation plant 10 which is supplied with air via an inlet conduit 11. In the air fractionation plant 10, the air is fractionated into its constituents. Plants of this kind are known per se from the prior art and there is therefore no need at this point for any more detailed elucidation of the air fractionation plant 10. From this air fractionation plant 10, via an outlet conduit 12, the oxygen component which is not required for the ammonia production is removed. The nitrogen obtained in the air fractionation is supplied as the first reactant (optionally with additions of argon) via the feed conduit 13 to an electrolysis cell 14.

The plant shown in FIG. 1 further comprises a steam generator 15 which is supplied with liquid water via the inlet conduit 16. The water vapor produced in the steam generator 15 is supplied as the second reactant via the feed conduit 17 to the electrolysis cell 14. Oxygen and any water obtained in the electrolysis cell 14 can be removed from the electrolysis cell 14 via conduit 18. The ammonia product produced in the electrolysis in the electrolysis cell 14 and impurities still present therein, such as, in particular, water vapor, nitrogen, hydrogen and argon, are guided via conduit 19 into a first separation apparatus 20 in which the ammonia is separated from further gaseous constituents. Water separated off in the separation apparatus 20 can be recycled via a recycle conduit 21 into the steam generator 15. The nitrogen, hydrogen and argon components separated off in the separation apparatus 20 can optionally be discharged from the circuit as purge via conduits 22 and 23 if accumulation of argon in the system is to be avoided. However, conduit 22 leads not only to conduit 23 but also to a branch site, and so it is possible there to guide the hydrogen and nitrogen constituents separated off in the separation apparatus 20 via the recycle conduit 24 back to the feed conduit 13 and to feed these gases as reactants back into the electrolysis cell via this feed conduit 13.

The ammonia separated off in the separation apparatus 20 is fed via conduit 25 to a second separation apparatus 26 which is a refrigeration plant in which the ammonia can be purified by separating off further inert gases. In general, the ammonia is liquefied in the refrigeration plant 26 and can then be discharged via conduit 27 as liquid ammonia as product. The inert gases separated off in the second separation apparatus/refrigeration plant 26 can, if required, be recycled via the recycle conduit 28 into the first separation apparatus 20, where they can be separated off and removed via conduit 22.

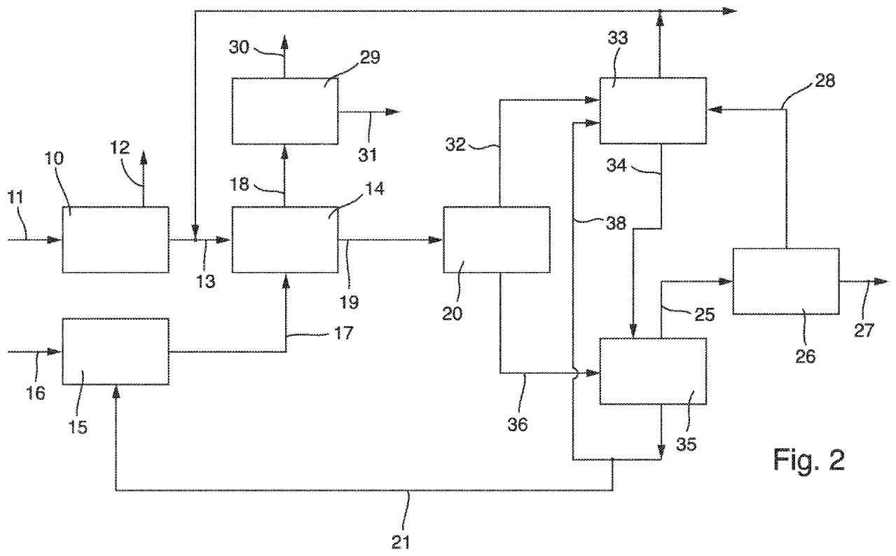

Reference is made hereinafter to FIG. 2, and this more detailed flow diagram is used to elucidate a further working example of the invention. Plant components of identical function are generally identified by the same reference numerals here. Via inlet conduit 16, the liquid water enters the steam generator 15, and thence the water vapor enters the electrolysis cell 14 via feed conduit 17. The nitrogen produced in the air fractionation plant 10 likewise enters the electrolysis cell 14 via the feed conduit 13, optionally in a mixture with argon. Oxygen and water are removed from the electrolysis cell 14 via conduit 18. By contrast with the variant described above, also provided in FIG. 2 is a further separation apparatus 29 into which conduit 18 opens as inlet conduit and in which the two components oxygen and water can be further separated from one another, such that it is then possible to separately remove the oxygen via conduit 30 on the one hand and the water via conduit 31.

The separation apparatus for separation of the individual components that leave the electrolysis cell 14 via conduit 19 with the ammonia as product stream from one another is somewhat more complex in FIG. 2. First of all, this gas stream enters a first separation apparatus 20 in which the two components nitrogen and argon are firstly separated from the product stream comprising ammonia and water. Nitrogen and argon are guided via a conduit 32 to a second separation apparatus 33, into which recycled inert gases can also be fed via conduit 28. In the separation apparatus 33, nitrogen and argon can optionally be separated from ammonia also present in this gas stream, in which case the ammonia obtained can be fed to the separation apparatus via conduit 34.

In the variant according to FIG. 2, there is provided a further separation apparatus 35 into which the ammonia separated off in the separation apparatus 20 passes via conduit 36, which is an inlet conduit for separation apparatus 35. The outlet conduit 25 of the separation apparatus 35 removes the ammonia as product gas to the separation apparatus 26 designed as a refrigeration plant. In this further separation apparatus 35, any water still present in the product stream can be removed in order then to be recycled to the steam generator 15 via the recycle conduit 21. Optionally, water separated off in the further separation apparatus 35 can be guided to the other separation apparatus 33 via a further conduit 38.

In the separation apparatus 26, inert gases can be separated from the ammonia and likewise fed to the separation apparatus 33 via conduit 28. In the separation apparatus 26, as described above, the ammonia gas is cooled down and then removed as liquid ammonia via conduit 27.

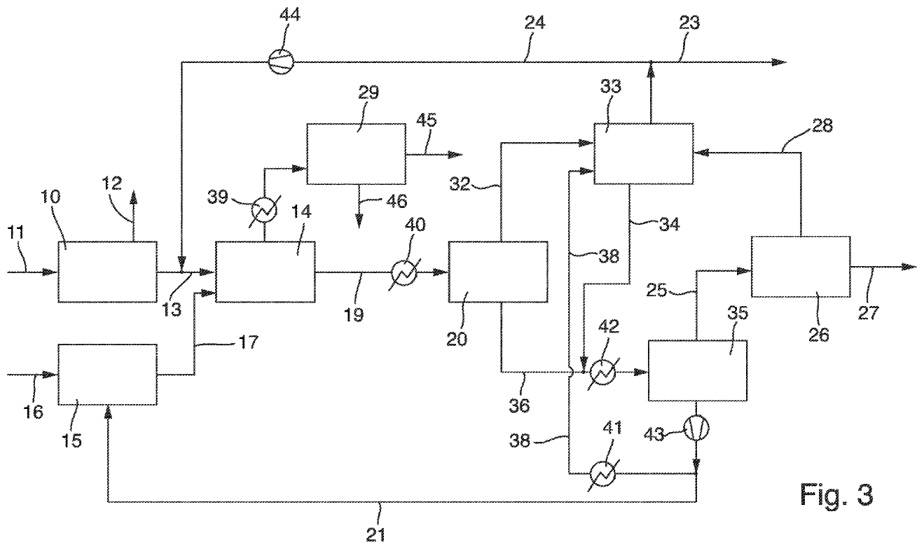

There follows an elucidation hereinafter, with reference to FIG. 3, of a further specific working example of the invention. In FIG. 3, plant components that have already been mentioned are each identified by the same reference numerals. The first reactant which is supplied to the electrolysis cell 14 via conduit 13 is nitrogen that has been obtained in the air fractionation plant 10 beforehand. The second reactant is water vapor which is produced from water in the steam generator 15 and fed to the electrolysis cell 14 via the feed conduit 17. The electrolysis is effected in the electrolysis cell 14, for example, at a temperature in the region of about 250° C. and a pressure in the order of magnitude of about 25 bara (bar absolute). The excess oxygen removed from the electrolysis cell and water are guided through a heat exchanger 39, where they are cooled to about 40° C., for example, and introduced into a separation apparatus 29 in which the two components oxygen 45 and water 46 are separated from one another. The product gas stream 19 from the electrolysis cell 14, which contains the ammonia as well as other components, can likewise be guided through a heat exchanger 40 and cooled therein, for example to a temperature of about 40° C., and is then fed to the separation apparatus 20. Nitrogen and argon are separated from the ammonia therein and then fed to a separation apparatus 33, which is a column in which water can be used to separate off ammonia, in which case the water can be guided through a further heat exchanger 41 via conduit 38.

The product stream 36 comprising the ammonia from the separation apparatus 20 can be heated by means of a further heat exchanger 42 and sent to the further separation apparatus 35 which is, for example, a desorber with reboiler and reflux condenser, in which water is separated from the ammonia-containing product stream and recycled via a pump 43 and recycle conduit 21 to the steam generator 15. In the separation apparatus 35, the ammonia is largely driven out of the ammonia-water mixture 36, by means of heat for example, such that, after recooling in the condenser, a cooled ammonia product stream at a temperature of about 57° C., for example, arrives via conduit 25 in the separation apparatus 26 which is, for example, an ammonia compression refrigeration plant, in which there is further separation of inert gas components and water from the ammonia. The ammonia leaves the refrigeration plant 26 as a cleaned product stream in the liquid state of matter at low temperatures, for example, −33° C. and atmospheric pressure via conduit 27, for example for subsequent storage in a tank.

The nitrogen and argon components leaving the column 33 can be partly discharged as a purge via conduit 23, or the nitrogen can be recycled via recycle conduit 24 and compressor 44 to feed conduit 13 in order thence to be fed back into the electrolysis cell 14 as reactant.

There follows a more detailed elucidation of the present invention with reference to a further working example. This example specifies further preferred process parameters for the inventive electrolytic production of ammonia. The nitrogen stream obtained in an air fractionation plant, which is used as one reactant stream for the process, may contain, for example, an argon content of less than 1 mol %, for example of 0.36 mol %, which is not specially separated off in the air fractionation plant and is thus also introduced into the process.

The steam required as the second reactant for the process can be obtained, for example, from demineralized water which is brought with a pump to an elevated pressure of more than 20 bar, for example to 25 bar, and then heated, such that the water evaporates and reaches a temperature of more than 200° C., for example 250° C. Alternatively, it would also be possible just to pump the water and not to produce the steam until it is within the electrolysis cell.

Both the abovementioned reactants are combined with the corresponding recycle streams and mixed together. Owing to the lower temperatures of the recycle streams, the mixed reactant stream should preferably be heated upstream of the cell in order to have attained, on entry into the electrolysis cell, the temperature desired therein of 250° C., for example.

An electrolysis experiment conducted in the context of the present invention, as a result of the spatial separation of the electrode spaces, resulted in two product streams. The product stream from the gas space above the anode contained all the oxygen formed and 75% to 85%, for example 81.8%, of the water present in the product streams since the anode reaction forms two moles of water per mole of oxygen. The desired ammonia product was removed from the gas space via the cathode together with unconverted reactants.

For separation, both product streams are distinctly cooled at first. Subsequently, with the aid of a flash cooler in each case, oxygen is separated from water, and nitrogen and argon from ammonia and water. Since there is still too much ammonia present in the stream consisting of nitrogen and argon, it is scrubbed out with water in a column. The gas stream thus cleaned contains only amounts of ammonia in the ppm range, especially less than 20 ppm, for example 7.83 ppm, of ammonia and can thus be used as recycle stream for nitrogen. A purge is conducted, which ensures that argon cannot accumulate in the circuit, in that a percentage of the circulation stream of, for example, less than 20%, especially less than 15%, preferably between about 5% and about 15%, for example 10%, of the circulation stream is removed from the system. It should be noted here that, owing to the pressure drops that occur here, it is advantageous to use a compressor to bring the recycle stream to the pressure level of the air fractionation plant.

The separation of ammonia and water can take place in a second column. Owing to the high solubility of ammonia in water, it is disadvantageous to use a separator at this point since, even at temperatures well above the boiling point of ammonia, virtually all the ammonia would remain dissolved in the water. The water obtained from the column bottoms has a high purity of more than 99%, for example of up to 99.99%, and can be used as wash water in the first column, and also as recycle water, in which case a pump should preferably be used for this stream. The top stream contains ammonia in a high purity of more than 99%, for example of up to 99.98%, which results firstly from the purity of the water in the column bottoms and from a specific design of the column, on account of which, in particular, the reflux ratio and the ratio of distillate to feed stream are specifically adjusted.

The refrigeration plant used may, for example, be a multistage ammonia condenser. The aim here is to achieve not only the liquefaction of the ammonia but lowering of the inert gas content in the product stream, which is achieved by means of the aforementioned ammonia condenser and an inert gas cooler. In the refrigeration plant, multiple compressors, for example three, are used to achieve the pressure levels specified there. This is more favorable than the use of just one compressor. The efficiencies of the compressors may, for example, be in the range from 0.82 (polytropic) to 0.98 (mechanical).

The ammonia leaves the refrigeration plant in liquid form at atmospheric pressure, such that subsequent storage in a tank is possible.

### LIST OF REFERENCE NUMERALS

10 air fractionation plant

11 inlet conduit for air

12 outlet conduit for O₂

13 feed conduit for N₂ to electrolysis cell

14 electrolysis cell

15 steam generator

16 inlet conduit for water

17 water/water vapor feed conduit to electrolysis cell

18 conduit for removal of O₂ and H₂O

19 conduit for the product stream from the electrolysis

20 first separation apparatus

21 recycle conduit

22 conduit

23 conduit for purge

24 recycle conduit

25 conduit for ammonia

26 separation apparatus/refrigeration plant

27 conduit for liquid ammonia

28 recycle conduit

29 separation apparatus

30 conduit for removal of oxygen

31 conduit for removal of water

32 conduit for nitrogen and argon

33 separation apparatus

34 conduit

35 separation apparatus

36 conduit for ammonia/water

38 conduit

39 heat exchanger

40 heat exchanger

41 heat exchanger

42 heat exchanger

43 pump

44 compressor

45 outlet conduit for O₂

46 outlet conduit for water

What is claimed is:

1. A process for preparing ammonia by electrolysis using an electrolysis cell, the process comprising:
feeding nitrogen as a first reactant into the electrolysis cell;
using water or water vapor as a second reactant for the electrolysis;
downstream of the electrolysis, in a first device, separating nitrogen from an ammonia-containing product stream removed from the electrolysis cell; and
separating water from the ammonia-containing product stream in a second device downstream of the first device.

2. The process of claim 1 comprising separating argon from the ammonia-containing product stream in the first device.

3. The process of claim 1 comprising recycling into the electrolysis at least one of the nitrogen or the water that is separated off from the ammonia-containing product stream.

4. The process of claim 1 comprising obtaining the nitrogen, which is the first reactant, from an air fractionation plant prior to feeding the nitrogen into the electrolysis cell.

5. The process of claim 4 comprising separating off argon prior to feeding the nitrogen into the electrolysis cell.

6. The process of claim 1 comprising removing from the electrolysis cell oxygen formed as a by-product in the electrolysis at an anode.

7. The process of claim 1 comprising purifying ammonia obtained in the electrolysis in a refrigeration plant.

8. The process of claim 1 comprising generating the water vapor used as the second reactant in a steam boiler and feeding the water vapor into the electrolysis cell as water vapor.

9. The process of claim 1 comprising:
feeding liquid water into the electrolysis cell; and
generating the water vapor used as the second reactant by supplying energy and by evaporation of the liquid water that has been fed into the electrolysis cell.

10. The process of claim 1 comprising effecting electrolytic conversion of the first and second reactants to ammonia at a temperature of at least 150° C.

11. The process of claim 1 comprising effecting electrolytic conversion of the first and second reactants to ammonia at a pressure of at least 15 bar.

12. The process of claim 1 comprising performing the electrolysis in batches via at least two electrolysis cells.

13. The process of claim 1 wherein for ammonia synthesis the process comprises using inert purge gasses at least partly as fuels for producing the water vapor.

14. A plant for preparing ammonia by electrolysis, the plant comprising:
an electrolysis cell for producing the ammonia;
a device for supplying gaseous nitrogen to the electrolysis cell;
a device for supplying water vapor or liquid water to the electrolysis cell;
a device for removing a product stream from the electrolysis cell;
a device for separating at least nitrogen from the product stream;
a device for separating water from the product stream, which device for separating water is disposed downstream of the device for separating at least nitrogen; and
a device for recycling water or water vapor to the electrolysis cell.

15. The plant of claim 14 comprising a device for recycling nitrogen to the electrolysis cell.

16. The plant of claim 14 comprising a refrigeration plant for purifying the ammonia, wherein the refrigeration plant is disposed downstream of the device for separating at least nitrogen from the product stream.

17. The plant of claim 14 comprising an air fractionation plant where the nitrogen supplied to the electrolysis cell is generated, wherein the air fractionation plant is disposed upstream of the electrolysis cell.

18. The plant of claim 14 comprising a steam generator where the water vapor supplied to the electrolysis cell is generated.

19. The plant of claim 14 comprising a device for separating oxygen from a by-product stream removed from the electrolysis cell.

20. The plant of claim 14 wherein the electrolysis cell is a first electrolysis cell, the plant comprising a second electrolysis cell for producing the ammonia.
